(19) United States
(12) Patent Application Publication
(10) Pub. No.: US 2012/0133859 A1
(43) Pub. Date: May 31, 2012

(54) LIQUID CRYSTAL DISPLAY DEVICE AND METHOD OF MANUFACTURING LIQUID CRYSTAL DISPLAY DEVICE

(76) Inventors: Jae-Lok CHA, Yongin-City (KR); Jong-Nam Lee, Yongin-City (KR)

(21) Appl. No.: 13/292,626

(22) Filed: Nov. 9, 2011

(30) Foreign Application Priority Data
Nov. 25, 2010 (KR) 10-2010-0118084

(51) Int. Cl. G02F 1/13357; H01J 9/00

(52) U.S. Cl. 349/61; 445/24

(57) ABSTRACT

A liquid crystal display (LCD) device includes a display module having a liquid crystal panel that forms an image and that includes a screen. The display module also has a backlight unit that emits backlight to the liquid crystal panel, and a lamination film that surrounds the display module. An extension direction of the lamination film formed during manufacture of the lamination film is directed between a horizontal direction and a vertical direction of the screen of the liquid crystal panel.

### CROSS-REFERENCE TO RELATED PATENT APPLICATION

This application claims the benefit of Korean Patent Application No. 10-2010-0118084, filed on Nov. 25, 2010, in the Korean Intellectual Property Office, and entitled: “Liquid Crystal Display Device and Method of Manufacturing Liquid Crystal Display Device,” the disclosure of which is incorporated herein in its entirety by reference.

### BACKGROUND

1. Field

Embodiments relate to liquid crystal display (LCD) devices and LCD devices including a lamination film, e.g., for surrounding a display module.

2. Description of the Related Art

A liquid crystal display (LCD) device may realize an image by controlling an amount of a light beam so as to correspond to an image signal. LCD devices have been used due to its characteristics such as the miniaturization, lightweight, and low power consumption. Recent developments include, e.g., a thin LCD device in consideration of the convenience for use in a portable device.

### SUMMARY

Embodiments may be realized by providing a liquid crystal display (LCD) device including a display module comprising a liquid crystal panel for forming an image, a backlight unit for emitting backlight to the liquid crystal panel, and a lamination film for surrounding the display module. An extension direction of the lamination film, which is formed during manufacture of the lamination film, is directed between a horizontal direction and a vertical direction of a screen of the liquid crystal panel.

The extension direction may be from about 35 to about 55 degrees based on the horizontal direction of the liquid crystal panel.

An adhesive film may be interposed between the lamination film and the display module.

Embodiments may also be realized by providing a method of manufacturing a liquid crystal display (LCD) device. The method includes preparing a display module including a liquid crystal panel for forming an image, a backlight unit for emitting backlight to the liquid crystal panel, and a lamination film for surrounding the display module. The method also includes directing an extension direction of the lamination film, which is formed during manufacture of the lamination film between a horizontal direction and a vertical direction of a screen of the liquid crystal panel so that the display module is surrounded by the lamination film.

The extension direction may be from about 35 to about 55 degrees based on the horizontal direction of the liquid crystal panel.

An adhesive film may be interposed between the lamination film and the display module.

### BRIEF DESCRIPTION OF THE DRAWINGS

Features will become apparent to those of ordinary skill in the art by describing exemplary embodiments with reference to the attached drawings in which:

FIG. 1 illustrates a cross-sectional view of a liquid crystal display (LCD) device according to an exemplary embodiment;

FIG. 2 illustrates a plan view of a lamination film of the LCD device of claim 1; and

FIG. 3 illustrates a case where the LCD display device of FIG. 1 includes the lamination film of FIG. 2.

### DETAILED DESCRIPTION

Example embodiments will now be described more fully with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when an element is referred to as being “on” another element, it can be directly on the other element, or intervening elements may also be present. In addition, it will also be understood that when an element is referred to as being “between” other elements, it can be the only element between the other elements, or one or more intervening elements may also be present. Like reference numerals refer to like elements throughout.

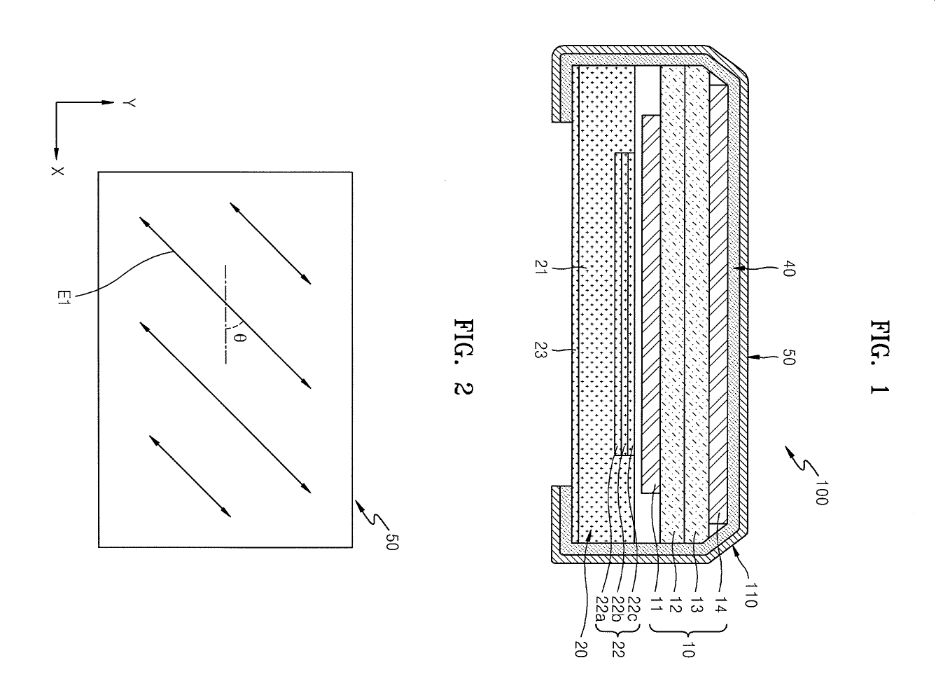

FIG. 1 illustrates a cross-sectional view of a liquid crystal display (LCD) device 100 according to an exemplary embodiment.

Referring to FIG. 1, the LCD device 100 may include a display module 110. The display module 110 may include a liquid crystal panel 10, e.g., for realizing an image, and a backlight unit 20, e.g., for applying light to the liquid crystal panel 10. The light applied by the backlight unit 20 may form an image for the LCD device 100 when the light is selectively transmitted through the liquid crystal panel 10.

According to an exemplary embodiment, the backlight unit 20 may include, e.g., a reflective sheet 23, a light guiding plate 21, and an optical sheet 22.

The light guiding plate 21 may guide light emitted from a lamp (not shown) towards the liquid crystal panel 10.

The optical sheet 22 may pass light emitted from the light guiding plate 21, e.g., so as to be incident on the liquid crystal panel 10. According to an exemplary embodiment, the optical sheet 22 may include, e.g., a diffusion sheet 22a for diffusing light, a prism sheet 22b for converting a proceeding angle of light to be perpendicular to the liquid crystal panel 10, and a protective sheet 22c for protecting a surface of the prism sheet 22b.

The reflective sheet 23 may be installed on a bottom surface of the light guiding plate 21. The reflective sheet 23 may reflect light from the bottom surface toward the liquid crystal panel 10.

The liquid crystal panel 10 may include, e.g., an upper substrate 13, a lower substrate 12. The liquid crystal panel 10 may include polarization plates 14 and 11 that are attached to upper and lower surfaces thereof. For example, the polarization plate 14 may be on, e.g., directly on, the upper substrate 13. The polarization plate 11 may be on, e.g., directly on, the lower substrate 12. A liquid crystal layer (not shown) may be interposed between the upper substrate 13 and the lower substrate 12.

The lower substrate 12 may include, e.g., formed thereon, a thin film transistor (TFT) (not shown) and/or a pixel electrode (not shown).

The upper substrate 13 may include, e.g., a color filter (not shown) for realizing colors, a black matrix (not shown) for reducing and/or preventing light from being filtered out, and/or a common electrode (not shown) facing the pixel electrode.

The display module 110 may be the surrounded by a lamination film 50. For example, the lamination film 50 may surround the liquid crystal panel 10 and the backlight unit 20 of the display module 110. The lamination film 50 may be formed of a resin, e.g., polyethylene terephthalate (PET). An adhesive film 40, e.g., an optical clear adhesive (OCA), may be interposed between the lamination film 50 and the display module 110. The adhesive film 40 may attach the lamination film 50 to the display module 110. The display module 110 including the liquid crystal panel 10 and the backlight unit 20 may be surrounded by the lamination film 50, which may be a thin lamination film, so as to be packetized.

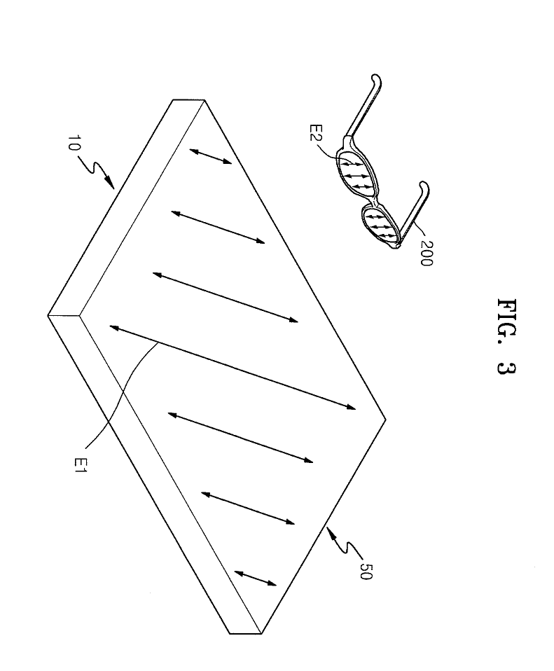

An extension direction E1, which may exhibit the polarization characteristics of the lamination film 50, may be directed between a horizontal direction X and a vertical direction Y, e.g., as shown in FIG. 2.

The lamination film 50 may be extended during manufacture of the lamination film 50, and consequentially the polarization characteristics of the lamination film 50 may exhibit to form an actual polarization pattern in the extension direction E1. The extension direction E1 may not be disposed in, e.g., such that it extends in a direction parallel to, the horizontal direction X or the vertical direction Y in a screen of the liquid crystal panel 10.

Referring to FIG. 3, polarization glasses 200 may have polarization patterns E2 of the vertical direction Y or the horizontal direction X. The polarization patterns E2 of the polarization glasses 200 may need to be formed in such an orientation as not to be completely perpendicular to the extension direction E1 of the lamination film 50.

Without intending to be bound by this theory, if the polarization patterns E2 of the polarization glasses 200 are perpendicular to the extension direction E1 of the lamination film 50, a user wearing the polarization glasses 200 may not be able to see an image. Thus, in order to minimize and/or prevent this inconvenience, the extension direction E1 of the lamination film 50 may be diagonally directed in the image, e.g., may be disposed in a direction diagonal to the image.

A slope θ, e.g., see FIG. 2, of the extension direction E1 may be, e.g., about 45±10 degrees, that is, from about 35 to about 55 degrees based on the horizontal direction X. The slope θ may be within a range that includes, but is not limited to, about 45±8 degrees, about 45±5 degrees, and about 45±2 degrees. The slope θ of the extension direction E1 may be measured with respect to a plane extending in the horizontal direction X on the display module 110. The slope θ may correspond to a angle θ measured relative to the horizontal direction X.

Irrespective of a case where the polarization patterns E2 of the polarization glasses 200 are formed in the horizontal direction X or the vertical direction Y, the image may be easily seen. For example, when the extension direction E1 is too close to the vertical direction Y, a user wearing the polarization glasses 200 having a polarization pattern of the horizontal direction X may experience some inconvenience of seeing an image. When the extension direction E1 is too close to the horizontal direction X, a user wearing the polarization glasses 200 having a polarization pattern of the vertical direction Y may experience some inconvenience of seeing an image. Thus, according to an exemplary embodiment, the extension direction E1 of the lamination film 50 may be directed so that the slope θ may be about 35 to about 55 degrees based on the horizontal direction X.

According to an exemplary method of manufacturing, the LCD device 100 may be manufactured in the following manner.

First, the display module 110, e.g., including the liquid crystal panel 10 and the backlight unit 20, and the lamination film 50 for surrounding the display module 110 may be prepared. The lamination film 50 may be cut, e.g., to a predetermined size, to surround the display module 110 so that the extension direction E1 thereof may be diagonally directly in a screen, e.g., as illustrated in FIG. 2.

Prior to attaching the lamination film 50 to the display module 110, the adhesive film 40 such as an OCA film may be attached to the display module 110. Then, the lamination film 50 may be attached to the adhesive film 40. Embodiments are not limited thereto, e.g., it may not be necessary to form the adhesive film 40 to attach the lamination film 50. The extension direction E1 of the lamination film 50 may be diagonally directed in a screen of the liquid crystal panel 10. For example, when attaching the lamination film 50, the extension direction E1 of the lamination film 50 may be directed at a slope of from about 35 to about 55 degrees with respect to a plane extending in the horizontal direction X.

Thus, as illustrated in FIG. 3, although a user wearing the polarization glasses 200 having the polarization pattern E2 of the horizontal direction X and the vertical direction Y sees an image, the user may easily see the image.

Accordingly, user's inconvenience due to the polarization characteristics of the lamination film 50 may be substantially reduced and/or substantially removed, thereby the reliability of a resultant product may be improved.

By way of summation and review, embodiments relate to liquid crystal display (LCD) devices and LCD devices including an improved structure of a lamination film for surrounding a display module. For example, light interference due to polarization characteristics of the lamination film may be reduced and/or prevented, thereby improving reliability.

Thin LCD devices, e.g., in consideration for convenience of use in portable LCD devices, are being developed. For example, the thin LCD devices may include a structure of surrounding a display module of the thin LCD device by using a lamination film formed of, e.g., polyethylene terephthalate (PET). The display module may include a backlight unit and a liquid crystal panel that are surrounded by a very thin lamination film, but not by a thick chassis, so as to be packaged to form the thin LCD device.

However, without intending to be bound by this theory, when the lamination film is extended while being manufactured, polarization characteristics may be generated in an extension direction of the lamination film. The polarization characteristics may act in a manner similar to a polarization plate. For example, when the lamination film is extended, polarization characteristics may be generated, like in a case polarization patterns may be formed in the extension direction. When the lamination film is used to surround the display module, a screen of a display module may be affected by the extension direction.

For example, when a user wearing sun glasses having a polarization pattern formed in one direction sees an image, if the polarization pattern of the sun glasses is perpendicular to a polarization pattern of a lamination film surrounding the screen of the display module, light interference may be caused so that the user may not see the image well. With regard to polarization glasses, e.g., polarized sunglasses, a polarization pattern may be vertically formed in order to block sunlight having polarization characteristics of a horizontal direction. If a polarization pattern of a lamination film on the LCD device is perpendicular to the polarization direction of the polarization glasses, the user may not see the image well.

With regard to the above, embodiments may be realized by providing a liquid crystal display (LCD) device that reduces and/or prevents light interference due to polarization characteristics of a lamination film surrounding a display module of the LCD device. While a user may not experience inconvenience of seeing an image with naked eyes, many users wear glasses may experience inconvenience. The embodiments disclosed herein circumvent such a condition.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A liquid crystal display (LCD) device comprising:
a display module including:
a liquid crystal panel that forms an image and that includes a screen; and
a backlight unit that emits backlight to the liquid crystal panel; and
a lamination film that surrounds the display module,
wherein an extension direction of the lamination film formed during manufacture of the lamination film is directed between a horizontal direction and a vertical direction of the screen of the liquid crystal panel.

2. The LCD device as claimed in claim 1, wherein the extension direction is from about 35 to about 55 degrees based on the horizontal direction of the screen of the liquid crystal panel.

3. The LCD device as claimed in claim 1, wherein an adhesive film is interposed between the lamination film and the display module.

4. A method of manufacturing a liquid crystal display (LCD) device, the method comprising:
preparing a display module including a liquid crystal panel that forms an image and that includes a screen, and a backlight unit that emits backlight to the liquid crystal panel; and
directing an extension direction of a lamination film formed during manufacture of the lamination film between a horizontal direction and a vertical direction of the screen of the liquid crystal panel so that the display module is surrounded by the lamination film.

5. The method as claimed in claim 4, wherein the extension direction is from about 35 to about 55 degrees based on the horizontal direction of the screen of the liquid crystal panel.

6. The method as claimed in claim 4, wherein an adhesive film is interposed between the lamination film and the display module.
